(19) United States
(12) Patent Application Publication
(10) Pub. No.: US 2025/0069207 A1
(43) Pub. Date: Feb. 27, 2025

(54) METHOD AND SYSTEM FOR CCTV RADIAL DISTORTION ESTIMATION WITH LOW-COMPLEXITY

(71) Applicant: Korea Electronics Technology Institute, Seongnam-si (KR)

(72) Inventors: Ki Woong KWON, Seoul (KR); Seung Hyeon PARK, Yongin-si (KR); Sang Hun KIM, Suwon-si (KR)

(73) Assignee: Korea Electronics Technology Institute, Seongnam-si (KR)

(21) Appl. No.: 18/781,142

(22) Filed: Jul. 23, 2024

(30) Foreign Application Priority Data
Aug. 24, 2023 (KR) 10-2023-0111318

(51) Int. Cl. G06T 5/80; G06T 5/20; G06T 7/13

(52) U.S. Cl. CPC G06T 5/80; G06T 5/20; G06T 7/13

(57) ABSTRACT

There are provided a method and a system for CCTV radial distortion estimation with low-complexity. An image distortion estimation method according to an embodiment includes: adding a certain distortion to an inputted image; detecting outlines from the image to which the distortion is added; detecting straight lines from the detected outlines; calculating a sum of the detected straight lines; performing the above operations N times, and determining parameters of an objective function by fitting an ‘objective function resulting from modeling of a sum of detected straight lines caused by an added distortion’ to the N distortions and the N sums; and estimating a distortion on the image by using the objective function the parameters of which are determined. Accordingly, the method does not need a cumbersome process since a separate reference image is not used, and is performed fast due to low-complexity of computation and less resources are required, and furthermore, relatively accurate distortion estimation is possible only with one image.

### CROSS-REFERENCE TO RELATED APPLICATION(S) AND CLAIM OF PRIORITY

This application is based on and claims priority under 35 U.S.C. § 119 to Korean Patent Application No. 10-2023-0111318, filed on Aug. 24, 2023, in the Korean Intellectual Property Office, the disclosure of which is herein incorporated by reference in its entirety.

### BACKGROUND

### Field

The disclosure relates to image distortion estimation, and more particularly, to a method and a system for estimating and correcting a radial distortion occurring in a closed-circuit television (CCTV) image, etc.

### Description of Related Art

CCTVs are used for various purposes such as crime prevention, disaster prevention, monitoring of illegal acts. A CCTV may use a wide angle lens or a fish-eye lens capable of photographing a wider angle of view in order to achieve its purpose and enhance efficiency. Accordingly, a radial distortion inevitably occurs in a CCTV image.

In order to acquire more accurate information on sizes or positions of things in an image, such a distorted image should be corrected, and information may be used for various purposes. Accordingly, image distortion correction is essential.

However, there are problems that a reference image is needed to correct an image distortion and complex computation is required.

### SUMMARY

The disclosure has been developed in order to solve the above-described problems, and an object of the disclosure is to provide a method and a system for image distortion estimation, which are capable of performing relatively accurate distortion estimation with low-complexity without using a separate reference image.

To achieve the above-described object, an image distortion estimation method may include: receiving an input of an image; adding a certain distortion to the inputted image; detecting outlines from the image to which the distortion is added; detecting straight lines from the detected outlines; calculating a sum of the detected straight lines; performing addition of the distortion and calculation of the sum N times, and determining parameters of an objective function by fitting an ‘objective function resulting from modeling of a sum of detected straight lines caused by an added distortion’ to the N distortions and the N sums; and estimating a distortion on the image by using the objective function the parameters of which are determined.

Detecting the outlines may include detecting the outlines by using a Canny edge filter.

Detecting the straight lines may include detecting the straight lines by using probabilistic Hough transform.

A distortion in the objective function may be expressed by one distortion value.

The distortion value may be k in the following equation:

$${r}_{u} \approx r ( 1 + {kr}^{2} )$$

The above equation may be a result of simplifying the following equation, which models an image distortion, by leaving only the first, second terms in the bracket:

$${r}_{u} = r ( 1 + {k}_{1} {r}^{2} + {k}_{2} {r}^{4} + … + {k}_{n} {r}^{2 n} )$$

where r is a distance from a center of an image, and k₁, k₂, . . . , kₙ are distortion parameters, and rᵤ is a distorted distance.

Estimating the distortion may include estimating a distortion indicated by a distortion value that maximizes the objective function as the distortion on the image.

The objective function is expressed by the following equation:

$$y ( k ) = a \times {e}^{- {( k - b )}^{2} / {c}^{2}} + d$$

where y(k) is a sum of detected straight lines, k is a distortion value, and a, b, c, d are parameters that are estimated by function fitting.

The distortion value that maximizes the objective function may be b.

According to an embodiment, the image distortion estimation method may further include correcting the distortion of the image based on the estimated distortion.

According to another aspect of the disclosure, there is provided an image distortion estimation system including: a processor configured to: receive an input of an image; add a certain distortion to the inputted image; detect outlines from the image to which the distortion is added; detect straight lines from the detected outlines; calculate a sum of the detected straight lines; perform addition of the distortion and calculation of the sum N times, and determine parameters of an objective function by fitting an ‘objective function resulting from modeling of a sum of detected straight lines caused by an added distortion’ to the N distortions and the N sums; and estimate a distortion on the image by using the objective function the parameters of which are determined; and a storage unit configured to provide a storage space necessary for the processor.

According to still another aspect of the disclosure, there is provided an image distortion estimation method including: adding a certain distortion to an image; detecting straight lines from the image to which the distortion is added; calculating a sum of the detected straight lines; performing addition of the distortion and calculation of the sum N times, and determining parameters of an objective function by fitting an ‘objective function resulting from modeling of a sum of detected straight lines caused by an added distortion’ to the N distortions and the N sums; estimating a distortion on the image by using the objective function the parameters of which are determined; and correcting the distortion of the image based on the estimated distortion.

According to embodiments of the disclosure as described above, the image distortion estimation method does not need a cumbersome process since a separate reference image is not used, and is performed fast due to low-complexity of computation and less resources are required, and furthermore, relatively accurate distortion estimation is possible only with one image.

Other aspects, advantages, and salient features of the invention will become apparent to those skilled in the art from the following detailed description, which, taken in conjunction with the annexed drawings, discloses exemplary embodiments of the invention.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a view illustrating a distortion according to a distance from a center of an image;

FIG. 2 is a view illustrating image distortion estimation using a chessboard image;

FIG. 3 is a flowchart provided to explain an image distortion estimation method according to an embodiment of the disclosure;

FIG. 4 is a view illustrating an example of a CCTV image;

FIG. 5 is a view illustrating an example of a result of detecting outlines by applying a Canny edge filter;

FIG. 6 is a view illustrating an example of a result of detecting straight lines through probabilistic Hough transform;

FIG. 7 is a view illustrating comparison of distortion estimation results according to N;

FIG. 8 is a view illustrating comparison of distortion estimation results according to N;

FIG. 9 is a view illustrating comparison of variance of distortion estimation values according to N;

FIG. 10 is a view illustrating comparison of variance of distortion estimation values according to N;

FIGS. 11A and 11B are views illustrating comparison of an original CCTV image and a corrected image;

FIGS. 12A and 12B are views illustrating comparison of an original CCTV image and a corrected image; and

FIG. 13 is a view illustrating a configuration of an image distortion estimation system according to another embodiment of the disclosure.

### DETAILED DESCRIPTION

Hereinafter, the disclosure will be described in more detail with reference to the accompanying drawings.

### 1. Image Distortion

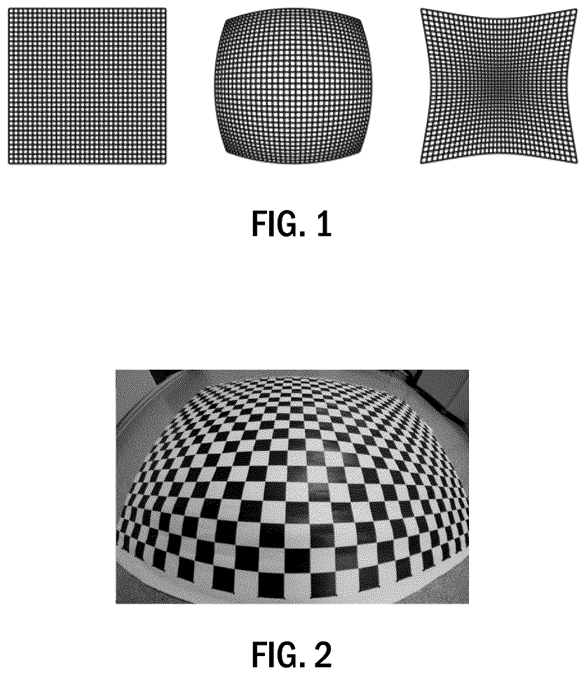

Distortions of camera lenses may be divided into a radial distortion and a tangential distortion according to a provoking cause of a distortion. The radial distortion may be caused by a refractive index of a lens and the degree of radial distortion varies according to a distance from the center of an image as shown in FIG. 1. The tangential distortion may be caused by an error or a deviation of products in a camera manufacturing process.

As an image distortion estimation method, a reference image in the form of a chessboard may be used as shown in FIG. 2 or a plurality of images may be used. However, such an image distortion estimation method may require much computing power due to high complexity of a computation process, and accordingly, there is a need for enhancement.

### 2. Simplified Image Distortion Model

Optical lenses have a difference in curvature according to an angle of view from a center. Such a difference in curvature may cause a radial distortion in a photographed image, and in particular, a radial distortion caused by a wide angle lens is referred to as a barrel type distortion. The radial distortion may be modeled according to a distance from the center of an image as shown in the following Equation 1:

$${r}_{u} = r ( 1 + {k}_{1} {r}^{2} + {k}_{2} {r}^{4} + … + {k}_{n} {r}^{2 n} ) \qquad Equation 1$$

Here, r is a distance from the center of an image, rᵤ is a distorted distance, and k₁, k₂, . . . , kₙ are distortion parameters. In an embodiment of the disclosure, in order to reduce complexity of computation, Equation 1 for modeling an image distortion may be simplified by applying n=1. That is, the following Equation 2, which is a result of simplifying by leaving only the first and second terms in the bracket of Equation 1, may be used. This is because the first parameter k₁ has the most visual impact on the distortion, and sufficient distortion improvement effect may be seen even by calculating only in the case of n=1.

$${r}_{u} \approx r ( 1 + {k}_{1} {r}^{2} ) \qquad Equation 2$$

Since one distortion parameter k is used by Equation 2 presented above, k₁ may be expressed k as shown in the following Equation 3:

$${r}_{u} \approx r ( 1 + {kr}^{2} ) \qquad Equation 3$$

### 3. Image Distortion Estimation

An embodiment of the disclosure provides a method for estimating a radial distortion in a CCTV image with low-complexity based on a radial distortion model simplified as shown in Equation 3 presented above. The image distortion estimation method according to an embodiment is capable of performing relatively accurate distortion estimation based on one image with low-complexity without using a separate reference image.

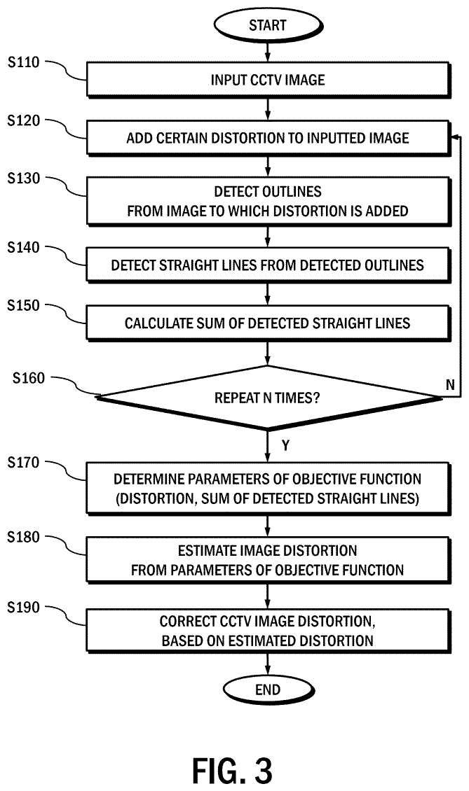

FIG. 3 is a flowchart provided to explain an image distortion estimation method according to an embodiment of the disclosure.

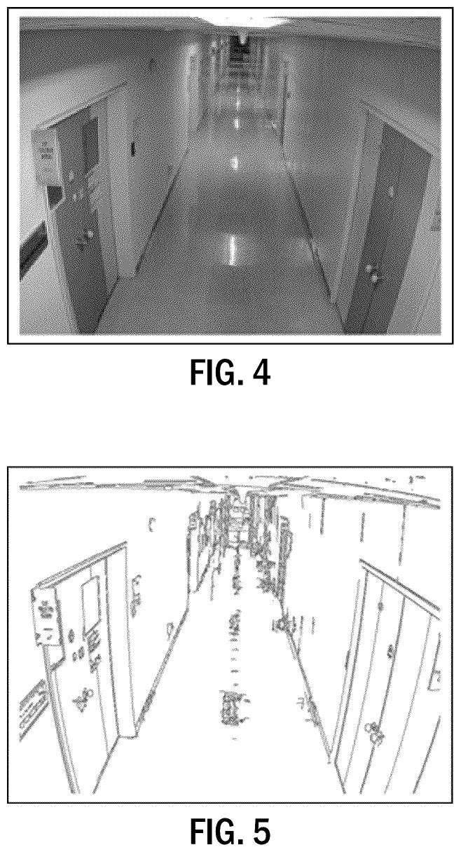

As shown in FIG. 3, one CCTV image is inputted (S110). FIG. 4 illustrates an example of a CCTV image inputted at step S110.

A certain distortion is added to the inputted image (S120), and outlines are detected from the image to which the distortion is added (S130). At step S130, outlines may be detected by using a Canny edge filter. However, outer methods may be used. FIG. 5 illustrates a result of detecting outlines by applying a Canny edge filter.

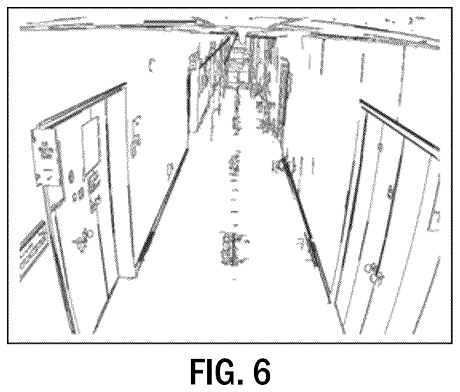

Straight lines are detected from the outlines detected at step S130 (S140). Straight lines are detected by using probabilistic Hough transform. FIG. 6 illustrates a result of detecting straight lines through probabilistic Hough transform.

Hough transform is a very useful method in detecting straight lines on an image. However, Hough transform has the demerit that complexity of computation is high and long time is required. Probabilistic Hough transform enhanced therefrom detects straight lines by using a certain point and thus has the merit of reducing complexity of computation. Accordingly, probabilistic Hough transform having the demerit of low complexity of computation is used in the embodiments of the disclosure.

A sum of the straight lines detected at step S140 is calculated (S150). The sum of the detected straight lines may refer to a sum of all lengths of the detected straight lines.

Steps S120 to S150 are performed N times (S160). By doing this, N distortions and N sums of detected straight lines are obtained.

Then, parameters of an objective function are determined by fitting “an objective function resulting from modeling of a sum of detected straight lines caused by an added distortion” to the N (distortions, sums of detected straight lines) (S170). The objective function used at step S170 is a function resulting from modeling of detected straight lines according to a degree of distortion of an image, and may be expressed by the following Equation 4:

$$y ( k ) = a \times {e}^{- {( k - b )}^{2} / {c}^{2}} + d \qquad Equation 4$$

Here, k is a value of an added distortion, y(k) is a sum of detected straight lines, and a, b, c, d are parameters that are determined through function fitting. In Equation 3 presented above, the distortion model is simplified only with one distortion parameter k and thus the distortion value used in Equation 4 presented above is only k.

A distortion indicated by a distortion value that maximizes the objective function determined at step S170 is estimated as a distortion on the image (S180). According to Equation 4 expressing the objective function, the distortion value (k) that maximizes the objective function is one of the parameters of the objective function, b. That is, the image distortion value k equals b(k=b).

To acquire a maximum value of a general objective function, a local extreme value should be calculated through differentiation. However, since the objective function proposed in the embodiment of the disclosure has a maximum value if k=b, a maximum value may be determined without a differentiation calculation process.

Based on the distortion estimated at step S180, the distortion of the CCTV image is corrected (S190).

### 4. Performance Verification

To verify performance of the image distortion estimation method according to an embodiment of the disclosure, a variance of distortion estimation values according to various N values (the number of repetitions of steps S120 to S150 in FIG. 3) was checked. An estimated distortion value k was set to a range between −0.2 and 0, and a distortion value that maximizes the sum of detected straight lines was used as a distortion estimation value as suggested in the embodiment of the disclosure.

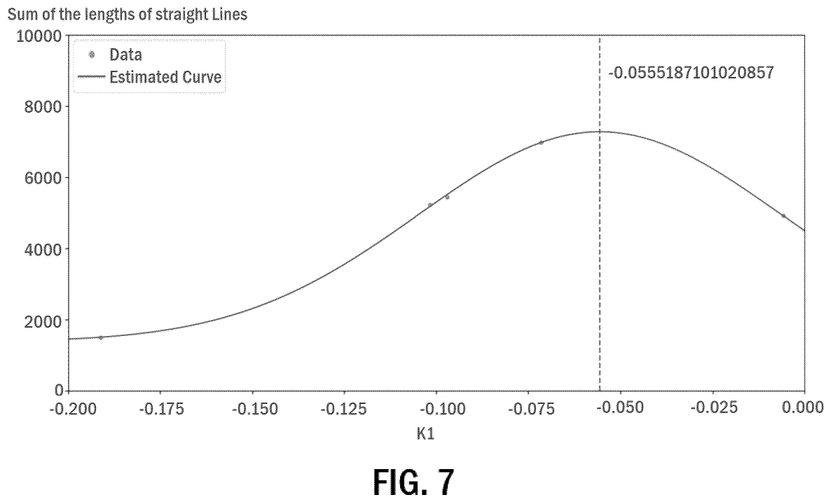

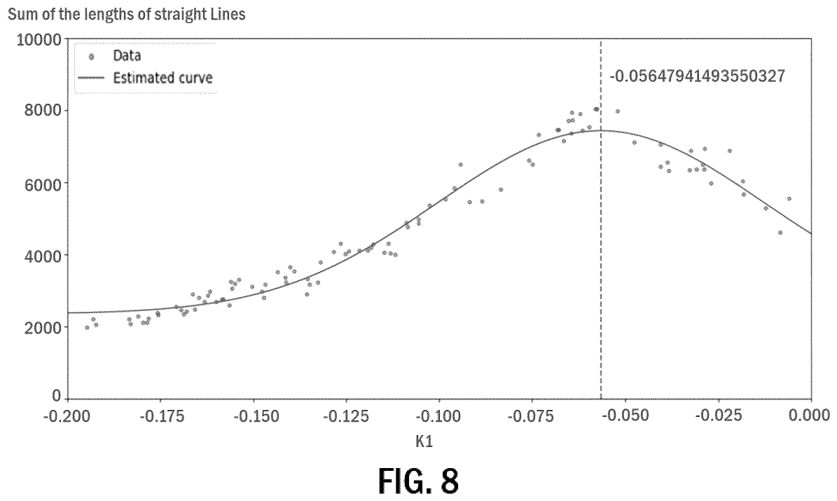

FIG. 7 shows a result of distortion estimation when objective function fitting is performed if N=5, and FIG. 8 shows a result of distortion estimation when objective function fitting is performed if N=100. It can be seen that similar distortion estimation results are shown although there is a big difference in complexity of computation.

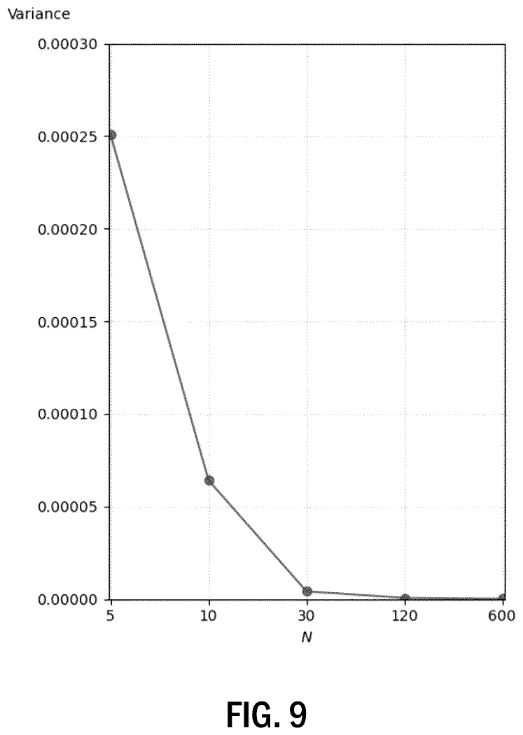

FIG. 9 shows a variance absolute value of distortion estimation values of a CCTV image according to N. If N increases, the variance decreases, showing robust performance. However, even if N is small, the variance is very small and thus it can be seen that N is not greatly insufficient for absolute performance.

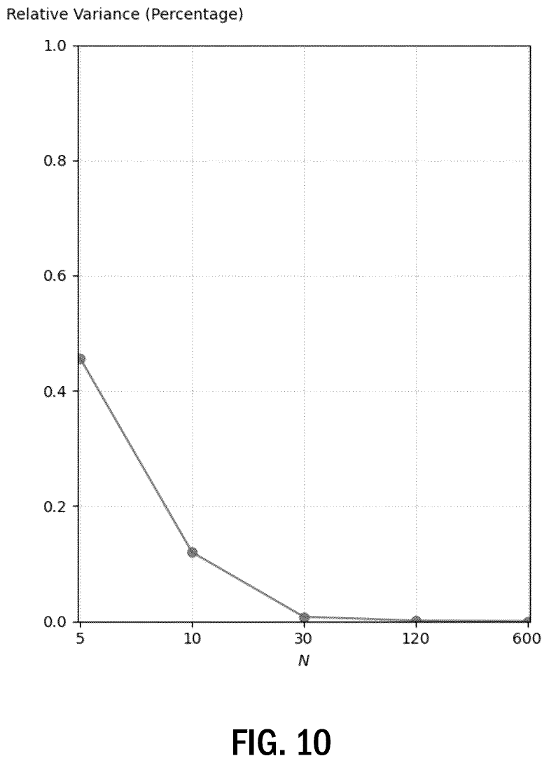

FIG. 10 shows relative variance of distortion estimation values, that is, relative variance obtained by dividing variance by an estimation value (percent basis). Even if N is the smallest value, 5, the relative variance shows very robust performance of about 0.5 percent.

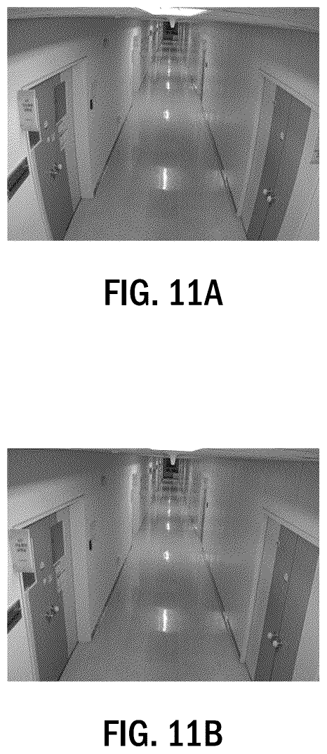

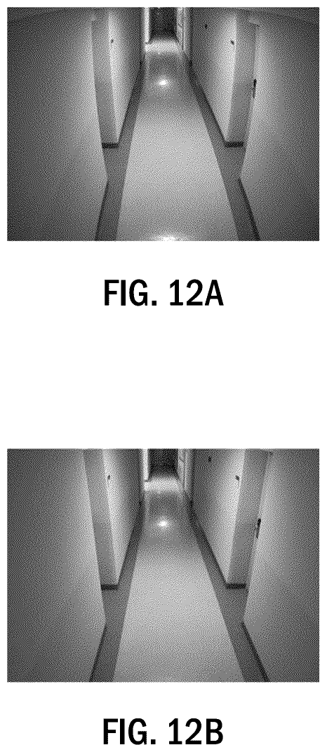

In FIGS. 11A and 12A, images are original CCTV images. In FIGS. 11B and 12B, images are images that are corrected by using a distortion estimation value after N is set to 10 (N=10). It can be seen that a distortion on a screen is enhanced and a more accurate image is obtained.

### 5. Image Distortion Estimation System

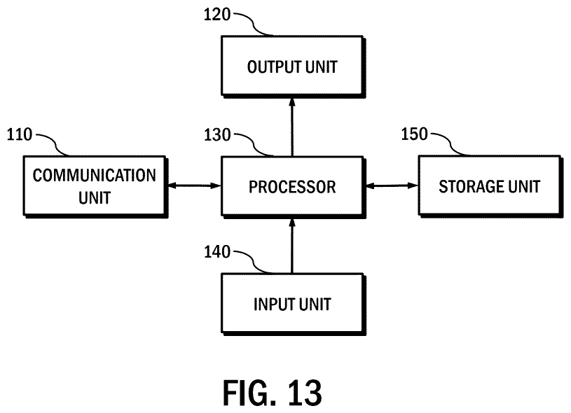

FIG. 13 is a view illustrating a configuration of an image distortion estimation system according to another embodiment of the disclosure. The image distortion estimation system according to an embodiment may be implemented by a computing system which includes a communication unit 110, an output unit 120, a processor 130, an input unit 140, and a storage unit 150.

The communication unit 110 is a communication interface for connecting to an external network or an external device, and receives an image from a CCTV camera. The output unit 120 is an output means for displaying a result of computing by the processor 130, and the input unit 140 is a user interface for receiving a user command and delivering the user command to the processor 130.

The processor 130 estimates and corrects an image distortion according to the procedure shown in FIG. 3 described above. The storage unit 150 provides a storage space necessary for functions and operations of the processor 130.

### 6. Variations

Up to now, a method for distortion estimation using only one image without a reference image with low-complexity has been described in detail with reference to preferred embodiments.

Accordingly, the method does not need a cumbersome process since a separate reference image is not used, and is performed fast due to low-complexity of computation and less resources are required, and furthermore, relatively accurate distortion estimation is possible only with one image.

The technical concept of the disclosure may be applied to a computer-readable recording medium which records a computer program for performing the functions of the apparatus and the method according to the present embodiments. In addition, the technical idea according to various embodiments of the disclosure may be implemented in the form of a computer readable code recorded on the computer-readable recording medium. The computer-readable recording medium may be any data storage device that can be read by a computer and can store data. For example, the computer-readable recording medium may be a read only memory (ROM), a random access memory (RAM), a CD-ROM, a magnetic tape, a floppy disk, an optical disk, a hard disk drive, or the like. A computer readable code or program that is stored in the computer readable recording medium may be transmitted via a network connected between computers.

In addition, while preferred embodiments of the present disclosure have been illustrated and described, the present disclosure is not limited to the above-described specific embodiments. Various changes can be made by a person skilled in the at without departing from the scope of the present disclosure claimed in claims, and also, changed embodiments should not be understood as being separate from the technical idea or prospect of the present disclosure.

What is claimed is:

1. An image distortion estimation method comprising:
receiving an input of an image;
adding a certain distortion to the inputted image;
detecting outlines from the image to which the distortion is added;
detecting straight lines from the detected outlines;
calculating a sum of the detected straight lines;
performing addition of the distortion and calculation of the sum N times, and determining parameters of an objective function by fitting an ‘objective function resulting from modeling of a sum of detected straight lines caused by an added distortion’ to the N distortions and the N sums; and
estimating a distortion on the image by using the objective function the parameters of which are determined.

2. The image distortion estimation method of claim 1, wherein detecting the outlines comprises detecting the outlines by using a Canny edge filter.

3. The image distortion estimation method of claim 1, wherein detecting the straight lines comprises detecting the straight lines by using probabilistic Hough transform.

4. The image distortion estimation method of claim 1, wherein a distortion in the objective function is expressed by one distortion value.

5. The image distortion estimation method of claim 4, wherein the distortion value is k in the following equation:
$${r}_{u} \approx r ( 1 + {kr}^{2} )$$
wherein the above equation is a result of simplifying the following equation, which models an image distortion, by leaving only the first, second terms in the bracket:
$${r}_{u} = r ( 1 + {k}_{1} {r}^{2} + {k}_{2} {r}^{4} + … + {k}_{n} {r}^{2 n} )$$
where r is a distance from a center of an image, and k₁, k₂, . . . , kₙ are distortion parameters, and rᵤ is a distorted distance.

6. The image distortion estimation method of claim 1, wherein estimating the distortion comprises estimating a distortion indicated by a distortion value that maximizes the objective function as the distortion on the image.

7. The image distortion estimation method of claim 6, wherein the objective function is expressed by the following equation:
$$y ( k ) = a \times {e}^{- {( k - b )}^{2} / {c}^{2}} + d$$
where y(k) is a sum of detected straight lines, k is a distortion value, and a, b, c, d are parameters that are estimated by function fitting.

8. The image distortion estimation method of claim 7, wherein the distortion value that maximizes the objective function is b.

9. The image distortion estimation method of claim 6, further comprising correcting the distortion of the image based on the estimated distortion.

10. An image distortion estimation system comprising:
a processor configured to: receive an input of an image; add a certain distortion to the inputted image; detect outlines from the image to which the distortion is added; detect straight lines from the detected outlines; calculate a sum of the detected straight lines; perform addition of the distortion and calculation of the sum N times, and determine parameters of an objective function by fitting an ‘objective function resulting from modeling of a sum of detected straight lines caused by an added distortion’ to the N distortions and the N sums; and estimate a distortion on the image by using the objective function the parameters of which are determined; and
a storage unit configured to provide a storage space necessary for the processor.

11. An image distortion estimation method comprising:
adding a certain distortion to an image;
detecting straight lines from the image to which the distortion is added;
calculating a sum of the detected straight lines;
performing addition of the distortion and calculation of the sum N times, and determining parameters of an objective function by fitting an ‘objective function resulting from modeling of a sum of detected straight lines caused by an added distortion’ to the N distortions and the N sums;
estimating a distortion on the image by using the objective function the parameters of which are determined; and
correcting the distortion of the image based on the estimated distortion.
